(19) United States
(12) Patent Application Publication
(10) Pub. No.: US 2002/0145374 A1
(43) Pub. Date: Oct. 10, 2002

(54) Two-piece base for lamp

(75) Inventor: Liao Ming-Hong, Taipei (TW)

Correspondence Address: Timothy E. Nauman, FAY, SHARPE, FAGAN, MINNICH & McKEE, LLP, 7th Floor, 1100 Superior Avenue, Cleveland, OH, 44114-2516, US

(73) Assignee: EIKO, LTD., Shawnee, KS

(21) Appl. No.: 09/827,300

(22) Filed: Apr. 5, 2001

(51) Int. Cl. H01J 5/48

(52) U.S. Cl. 313/318.01

(57) ABSTRACT

A two-piece lamp base assembly is assembled without fusing or welding the components together. A first portion has a cavity that receives a press seal of a lamp. A second or annular portion is slid over a reduced dimension region of the first portion to properly position and locate conductor wires extending from a lamp envelope. The annular portion snap-fits over shoulder and is locked between a shoulder and stop surface to hold the conductor wires in place.

### BACKGROUND OF THE INVENTION

This invention pertains to the art of lamps, and more particularly to lamps having a press seal. The invention is particularly applicable to an automotive or miniature-type incandescent lamp and will be described with reference thereto. It will be appreciated, however, that the invention may be employed in related lamp environments and applications where it is important to hold a press seal within a base cavity, accurately locate lead wires from the lamp, and simplify manufacturing of the lamp.

U.S. Pat. No. 6,056,417 is commonly owned by the assignee of the present invention and is expressly incorporated herein by reference. It relates to a two part base assembly in which a first base portion receives a second or annular base portion that is slid over a reduced dimension region of the first base portion. A cavity defined in the first bas portion receives the press seal of the lamp. The first and second base portions are fused or sonically welded together to form an integral base member. Although this arrangement has met with commercial success, there is an added capital cost of fusing/welding equipment, fixtures, etc., required to connect the first and second base portions into a completed lamp base, as well as further manufacturing steps and attendant costs.

The life of these lamps is also affected by thermal considerations. Particularly, dissipating the heat generated by the lamp leads to longer life and, consequently, reduces the frequency of replacing the lamps. It is believed that prior designs such as disclosed in U.S. Pat. No. 6,056,417 can be improved to improve on lamp life expectancy.

Thus, a need exists for an alternative assembly and manufacturing process that achieves the objectives of accurately locating conductor wires for good electrical connection and preventing adjacent lead wires from contacting one another in a manner that is reliable, simple, cost efficient, repeatable, and addresses thermal considerations.

### BRIEF SUMMARY OF THE INVENTION

The present invention contemplates a new and improved base of the type that receives a press seal of a lamp and overcomes the noted problems relative to securing conductors in a reliable and economical manner.

A two-piece base assembly includes a first portion having a snap-fit shoulder over which a second or annular portion is advanced for one-way, assembled insertion.

Preferably, the snap-fit shoulder is circumferentially discontinuous and engages an undersurface of the annular member to securely engage the annular member against a stop surface on the first portion.

A principal advantage of the invention resides in a reduced cost of manufacturing the lamp assembly.

Another advantage of the invention relates to the simplified manner of securing the lamp portions together.

Yet another advantage is realized by the simple, accurate manner in which the conductor wires are aligned along lamp.

A further advantage is obtained by the improved heat dissipation of the lamp assembly.

Still other advantages and benefits of the invention will become apparent to those skilled in the art upon a reading and understanding of the following detailed description.

### BRIEF DESCRIPTION OF THE DRAWINGS

FIG. 1 is an isometric view of a prior art lamp base assembly.

FIG. 2 is an exploded view of the two-piece base assembly of the present invention.

FIG. 3 is an elevational view of the first portion of the base assembly.

FIG. 4 is an end view of the first portion of FIG. 3.

FIG. 5 is a top plan view thereof.

FIG. 6 is a bottom plan view thereof.

FIG. 7 is a cross-sectional view taken generally along the lines 7-7 of FIG. 3.

FIG. 8 is a cross-sectional view taken generally along the lines 8-8 of FIG. 3.

FIG. 9 is a cross-sectional view taken generally along lines 9-9 of FIG. 4.

FIG. 10 is a plan view of the second portion of the base assembly.

FIG. 11 is a longitudinal cross-sectional view of a second embodiment of the first portion of the base assembly.

### DETAILED DESCRIPTION OF THE PREFERRED EMBODIMENTS

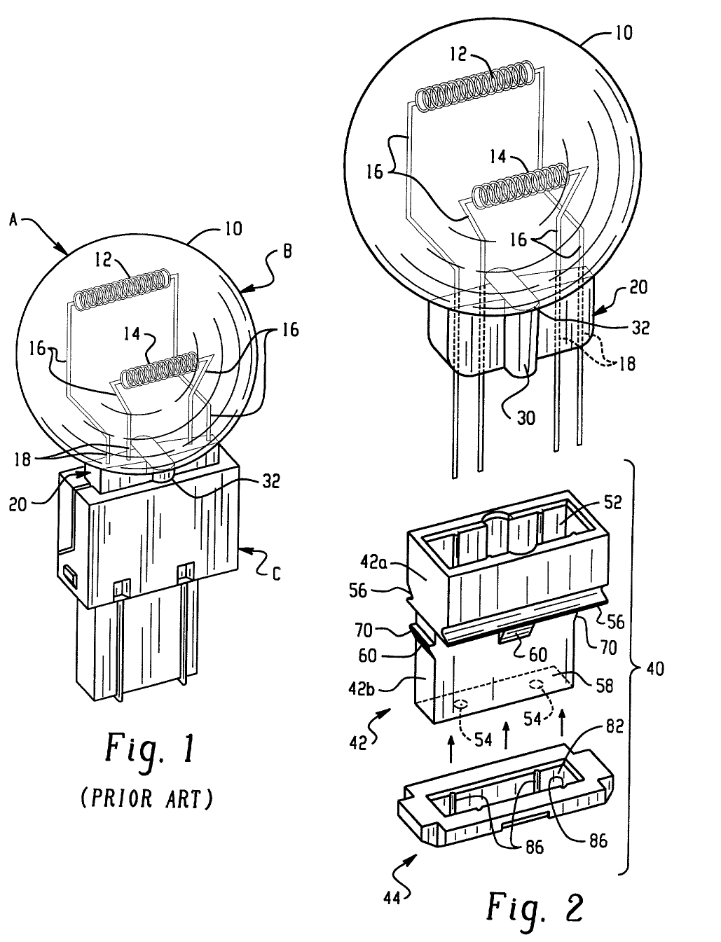

FIG. 1 discloses a lamp assembly A having a lamp or light source B received in a molded base member C. The light source is shown as an incandescent source having an envelope 10 enclosing first and second filaments 12, 14, although it will be appreciated that the light source may be either a single or dual filament arrangement. Leads wires 16 each have a first end extending from the filaments, locating and supporting the filaments at a desired position within the envelope and providing a conductive path for electric current from an external source (not shown) to the filaments. Second ends of the lead wires extend outwardly from the envelope, with intermediate portions of the lead wires are hermetically sealed in a press seal region 20 of the envelope. A mechanical deformation or pressing operation is provided on a base portion of the envelope to seal the lead wires. An exhaust tube 30 is centrally located in the press seal region to establish a proper atmosphere in the lamp envelope. The exhaust tube is subsequently sealed, or tipped off, to maintain the desired environment therein.

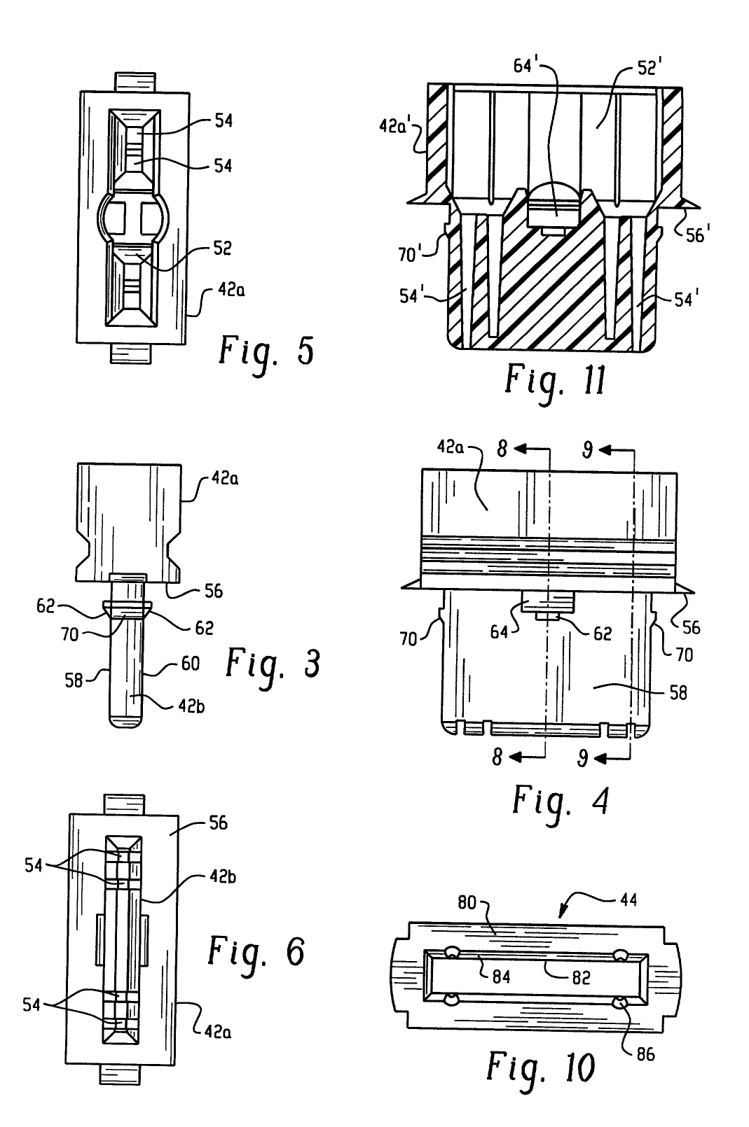

Turning to FIGS. 2-10, the base assembly 40 is preferably comprised of first and second portions 42, 44. The first portion 42 is a molded plastic assembly 50 having a first or upper regions 42a that has a cavity 52 extending inwardly from one end and dimensioned to receive the press seal regions and exhaust tube of the envelope. The upper regions and cavity have a substantially rectangular cross-section that conforms to the periphery of the lamp press seal region. Lead wire openings 54 are formed in an opposite end of the first base portion, particularly a second or lower, reduced dimensioned region 42b. For reasons which will become more apparent below, the interface between the first and second regions of the first portion of the base defines an annular shoulder or stop surface 56. The openings 54 permit a desired number of lead wires 16 to pass outwardly from the first base portion where the lead wires are then wrapped or turned upwardly for receipt along one of opposed planar surfaces 58, 60 of the reduced dimension region of the lamp base. Additionally, snap-fit shoulders 62 extend outwardly from central portions of the planar surfaces at a spaced location below the stop surface. The shoulders 62 are advantageously separated from the planar surfaces by cutout regions 64 which allow flexibility of the snap-fit shoulders, i.e., allow the shoulders to flex inwardly and outwardly relative to the planar surfaces. The cutout regions 64 are also dimensioned to serve as vents for enhancing heat dissipation from the lamp assembly. The vents communicate with the cavity that receives the press seal region of the lamp envelope and address the thermal considerations and lead to longer life and less frequent replacement of the lamps. It will be appreciated, however, that the cutout regions or vents can adopt a wide variety of configurations without departing from the scope and intent of the subject invention. For example, the cutout regions need not necessarily be provided around the shoulders, although the combination does offer the benefits of shoulder flexibility while simultaneously serving thermal issues. Snap-fit shoulders 70, are also provided at opposite ends of the base member, again, at a spaced location below the stop surface 56. These shoulders, like the snap-fit shoulders 62, provide for ease of assembly.

The second or annular portion of the two-piece base assembly (FIG. 10) is slid over the reduced dimension region of the first portion of the base assembly. The annular portion 80 has a central opening 82 that is sufficiently flexible for receipt over the snap-fit shoulders 62, 70. An internal chamber 84 is provided about the inner periphery of the annular portion to facilitate guiding receipt of the annular member over the first base portion. In addition, elongated recesses or grooves 86 proceed axially through the annular portion and are preferably disposed in spaced relation to guide the lead wires 16 along the planar surfaces 58, 60 of the first base portion. The dimension between the shoulders and the stop surface is substantially identical to the thickness of the annular member so that once the annular member snaps over the shoulders, it is axially locked in place between the shoulder and stop surface. In this manner, terminal ends of the conductor lead wires are pressed against the opposite planar surfaces and maintained in respective groove 86 provided along the internal surface of the annular member.

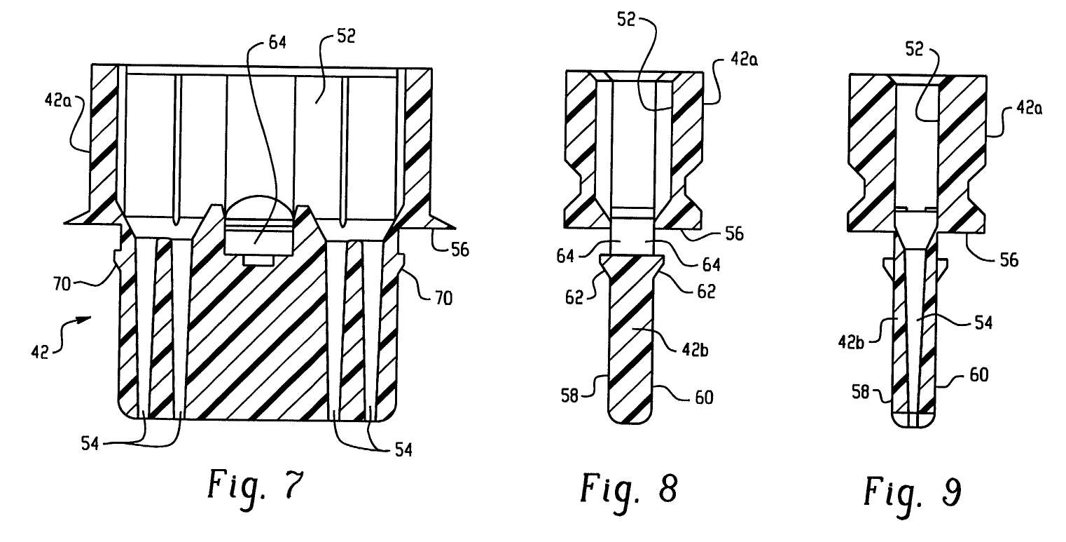

FIGS. 7 and 11 illustrate that the number of openings through the base member may be varied to accommodate pairs of lead wires. For example, only a pair of openings is provided, i.e., for a single filament, in the embodiment of FIG. 11 while two pairs of openings are provided in the embodiment of FIG. 7. Still another difference is that the dimensions of the snap-fit shoulders may vary with the single and dual filament arrangements. Preferably, a narrower dimension is provided for the dual filament assembly when compared to the single filament arrangement. However, the snap-fit relationship between the first and second base portions still operates and functions in substantially the same manner.

To summarize, an envelope of the light source includes one or two pairs of lead wires extending outwardly therefrom. The lead wires are inserted into the cavity 52 of the first portion of the base assembly. The openings are surrounded by tapered internal walls defined in a bottom of the cavity in surrounding relation with the openings. The lead wires are then bent toward one of the planar surfaces prior to advancing the annular portion 80 over the reduced dimension of the first portion. The grooves 86 enclose the lead wires and maintain a guiding receipt of the lead wires as the annular member is advanced toward the stop surface 56. The preselected circumferential spacing between the snap-fit shoulders precludes any interference with the lead wires as the annular member is advanced over the shoulders into assembled relation axially held between the stop surface and the snap-fit shoulders. In this manner, the two part base is easily assembled, the lead wires properly positioned at desired locations along the planar surfaces, and the envelope held in retaining engagement with the base without the need to fuse or weld the individual components together. Moreover, the snap-fit arrangement and particularly the cutout regions formed around the shoulders 60 allow for venting of the lamp portion received in the base assembly without any undesirable loss in function since the base portions need not be fused together which would otherwise entrap the heat in the base assembly.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

What is claimed is:

1. A base assembly for an incandescent lamp having a press seal region that encloses lead wires extending therefrom, the base assembly comprising:
a first portion having a cavity dimensioned to closely receive the press seal region therein and an opening communicating with the cavity through which lead wires extend, a snap-fit shoulder defined on the first portion and spaced from a stop surface on the first portion;
an annular second portion received between the snap-fit shoulder and the stop surface, the second portion aligning the lead wires along an external surface of the second portion.

2 The base assembly of claim 1 wherein the shoulder has a wedge shape.

3. The base assembly of claim 1 wherein the shoulder is defined by multiple shoulders circumferentially spaced about the base assembly.

4. The base assembly of claim 3 wherein the shoulder s are peripherally disposed about the first portion at locations between the lead wires.

5. The base assembly of claim 1 wherein the annular second portion includes grooves that receive the lead wires therein.

6. The base assembly of claim 5 wherein the shoulder s are peripherally disposed about the first portion at locations between the lead wires.

7. The base assembly of claim 1 wherein the annular second portion has a thickness substantially identical to an axial dimension between the stop surface and shoulder.

8. The base assembly of claim 1 further comprising a vent for improving heat dissipation of the lamp.

9. A lamp assembly comprising:
an envelope enclosing a filament and first and second lead wires supporting the filament in the envelope, the lead wires extending outwardly from the envelope through a press seal of the envelope;
a first base portion having a cavity dimensioned to closely receive the press seal region therein and an opening communicating with the cavity through which the lead wires extend, a snap-fit shoulder defined on the first portion and spaced from a stop surface on the first portion; and
an annular second base portion received between the snap-fit shoulder and the stop surface, the second base portion aligning the lead wires along an external surface of the second base portion.

10. The lamp assembly of claim 9 wherein the shoulder has a wedge shape.

11. The lamp assembly of claim 9 wherein the shoulder is defined by multiple shoulders circumferentially spaced about the first base portion.

12. The lamp assembly of claim 11 wherein the shoulders are peripherally disposed about the first base portion at locations between the lead wires.

13. The lamp assembly of claim 9 wherein the annular second base portion includes grooves that receive the lead wires therein.

14. The lamp assembly of claim 13 wherein the shoulder s are peripherally disposed about the first base portion at locations between the lead wires.

15. The lamp assembly of claim 9 wherein the annular second base portion has a thickness substantially identical to an axial dimension between the stop surface and shoulder.

16. The lamp assembly of claim 9 wherein the first base portion includes a vent communicating with the cavity for improving thermal characteristics of the lamp.

17. The lamp assembly of claim 16 wherein the vent is formed as a cutout region about the shoulder.
